(19) United States
(12) Patent Application Publication
(10) Pub. No.: US 2026/0096003 A1
(43) Pub. Date: Apr. 2, 2026

(54) DIELECTRIC BARRIER DISCHARGE DEVICE CONFIGURATIONS

(71) Applicant: AEROJET ROCKETDYNE, INC., Melbourne, FL (US)

(72) Inventor: Justin Pucci, Kenmore, WA (US)

(21) Appl. No.: 18/901,527

(22) Filed: Sep. 30, 2024

(51) Int. Cl. H05H 1/24

(52) U.S. Cl. CPC H05H 1/2418; H05H 1/2431

(57) ABSTRACT

A dielectric barrier discharge device includes a dielectric nozzle that circumscribes an interior cavity. The dielectric nozzle has a first end, a second end opposite the first end, an interior side, and an exterior side opposite the interior side. The interior cavity spans from the first end to the second end, and the interior cavity has an open end at the second end of the dielectric nozzle. There is a first electrode on the exterior side, and a second electrode in the interior cavity. A gas inlet is fluidly connected with the interior cavity, and there is a gap that runs between the second electrode and the interior side. The gap may vary in size along the second electrode. A power supply is electrically coupled with the first electrode and the second electrode.

### BACKGROUND

A dielectric barrier discharge (DBD) device includes two electrodes, one of which is covered in a dielectric barrier material. The electrodes are connected with an alternating current power source that drives electrical discharges in a gap between the electrodes. The discharges cause gas ionization every electrical half-cycle. The resulting plasma interacts with the surrounding air or other gaseous medium to induce a net flow, which is often referred to as an ionic wind or electrical wind. DBD devices are used as ozone generators, ultraviolet light lamps, plasma generators, and aerodynamic flow controllers, for example.

### SUMMARY

A dielectric barrier discharge according to an example of the present disclosure includes a dielectric nozzle that circumscribes an interior cavity. The dielectric nozzle has a first end, a second end opposite the first end, an interior side, and an exterior side opposite the interior side. The interior cavity spans from the first end to the second end, and the interior cavity has an open end at the second end of the dielectric nozzle. There is a first electrode on the exterior side, and a second electrode in the interior cavity. A gas inlet is fluidly connected with the interior cavity, and there is a gap that runs between the second electrode and the interior side. The gap may vary in size along the second electrode. A power supply is electrically coupled with the first electrode and the second electrode

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description. In this disclosure, like reference numerals designate like elements where appropriate and reference numerals with the addition of one-hundred or multiples thereof designate modified elements that are understood to incorporate the same features and benefits of the corresponding elements. The drawings that accompany the detailed description can be briefly described as follows.

FIG. 1 illustrates a coaxial configuration of a dielectric barrier discharge device.

FIG. 2 illustrates a convergent-divergent configuration of a dielectric barrier discharge device that integrates a electromagnet coil into the structure of the convergent-divergent portion.

FIG. 3 illustrates the device of FIG. 2 with electric field and magnetic field vectors.

FIG. 4 illustrates another example of a convergent-divergent configuration of a dielectric barrier discharge device that has a bobbin for the magnet.

FIG. 5 illustrates a metallic foil of the first electrode of the device of FIG. 2.

FIG. 6 illustrates a sectioned, three-dimensional view of the device of FIG. 4.

FIG. 7 illustrates a dielectric barrier discharge device that has a frustoconical electrode.

FIG. 8 illustrates a dielectric barrier discharge device that has a conical electrode.

FIGS. 9A, 9B, and 9C illustrate a dielectric barrier discharge device with different height second electrodes.

FIGS. 10A, 10B, and 10C illustrate a dielectric barrier discharge device with different length first electrodes.

FIG. 11 illustrates a dielectric barrier discharge device that has an axial electrode.

### DETAILED DESCRIPTION

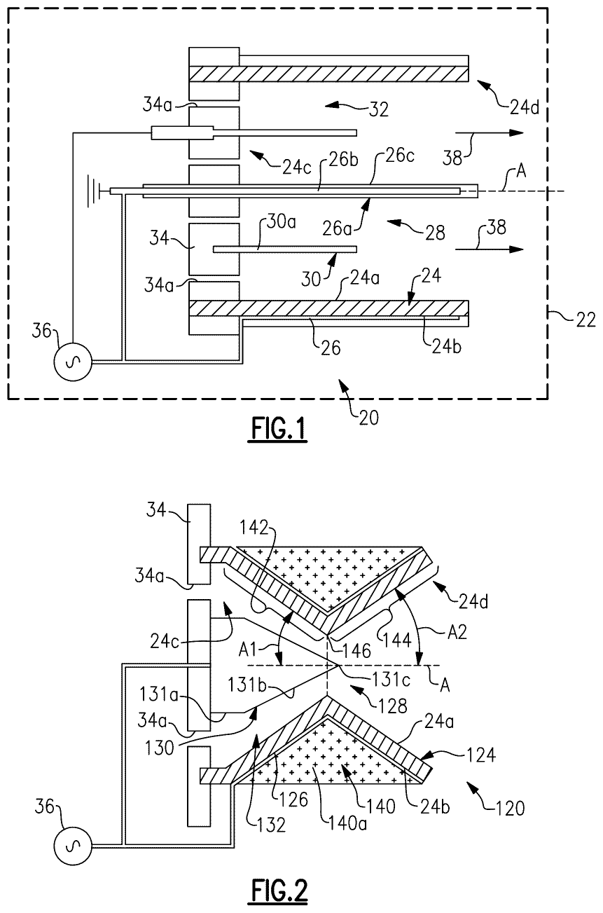

FIG. 1 illustrates a sectioned view of a dielectric barrier discharge device 20. The device 20 in this example is used in a thruster 22. Later example devices are also used in a thruster. The devices are not limited to use as such an application and may alternatively be used in many other applications, including but not limited to, a synthetic jet actuator for boundary layer control, an ozone generator, an ultraviolet light lamp, and a plasma generator.

The device 20 includes a dielectric nozzle 24 that has opposed first (interior) and second (exterior) sides 24a/24b, and first and second opposed ends 24c/24d. The second end 24d is open. For example, the dielectric nozzle 24 is made of a solid dielectric material, which is an electrical insulator that polarizes on the application of electric field due to shifting and net displacement of positive and negative charges. Many ceramics, mica, and quartz glass are considered dielectric materials. Further example dielectric materials include, but are not limited to, aluminum nitride, boron nitride, alumina, and borosilicate. The phrase “dielectric nozzle” refers to a conduit structure that is made of a dielectric material and that, due to its shape and dielectric properties, directs or modifies a flow of plasma.

There is a first electrode 26 on the exterior side 24b of the dielectric nozzle 24. For example, the first electrode 26 is an electrically conductive metallic foil that is wrapped around the dielectric nozzle 24. Both the first electrode 26 and the dielectric nozzle 24 are cylindrical about a central nozzle axis A and circumscribe an interior cavity 28. The interior cavity 28 spans from the first end 24c to the second end 24d of the dielectric nozzle 24.

There is a second electrode 30 in the interior cavity 28. In this example, the second electrode 30 has a cylindrical section 30a about the axis A that is coaxial with the dielectric nozzle 24 and the first electrode 26. The first electrode 26 also includes an electrode post section 26a that includes a wire 26b that is encased in a dielectric shell 26c. The post section 26a is disposed along the axis A so as to be coaxial with the cylindrical section 30a and the dielectric nozzle 24.

The cylindrical section 30a is spaced from the interior side 24a of the dielectric nozzle 24 such that there is a gap 32 that runs between the second electrode 30 and the interior side 24a. The gap 32 in this example is an annular region about the axis A, and the gap 32 is of a constant cross-section (in a radial plane perpendicular to the axis A) along the length of the cylinder section 30a.

The dielectric nozzle 24 and the second electrode 30 are attached with a backing plate 34. The backing plate 34 closes off the first end 24c of the dielectric nozzle 24 and includes one or more gas inlets 34a that is/are fluidly connected with the interior cavity 28. Although not shown, a gas source is fluidly connected with the backing plate 34, to provide a working gas to the interior cavity 28 through the gas inlet or inlets 34a. The working gas will depend in the end use of the device 20 and may be, but is not limited to, air, argon, or hydrazine, or mixture of these gases. The backing plate 34 also bounds an axial side of the interior cavity 28, while the opposed axial end of the interior cavity 28 is open at the second end 24d of the dielectric nozzle 24.

Power supply 36 is electrically coupled with the electrodes 26/30. For example, the power supply 36 is an alternating current source, though the power supply 36 may also include a direct current bias. In this example, the first electrode 26, including the post section 26a, is on the grounded side of the circuit, and the second electrode, including the cylindrical section 30a is on the voltage supply side of the circuit. The power supply 36, upon activation and with a supply of working gas, generates a plasma in the cavity 28. As represented by arrows 38, the plasma is expelled from the open end 24d of dielectric nozzle 24. All of the devices herein are useful with a variety of different working gases, which further enables multi-mode operation of the devices across various thruster technologies.

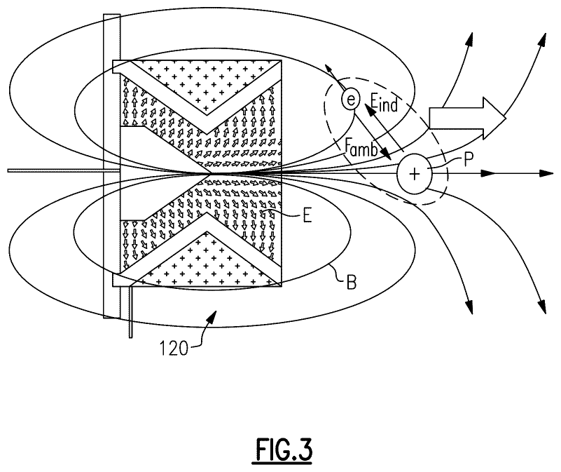

FIG. 2 illustrates a sectioned view of selected portions of another example of a device 120. In this example, the dielectric nozzle 124 has a convergent-divergent geometry, rather than cylindrical as in the device 20 in FIG. 1. For instance, the dielectric nozzle 124 defines a first section 142, a second section 144, and a throat 146 axially between the first section 142 and the second section 144. The first section 142 converges from the first end 24c to the throat 146. The second section 144 diverges from the throat 146 to the second end 24d. The throat 146 is a minimum cross-sectional area of the interior cavity 128. In the illustrated example, the throat 146 is discrete in that it occurs at a peak apex in the wall of the dielectric nozzle 124, but alternatively the peak could be broader so as to axially widen the throat 146 to a “band.” The first section 142 forms a convergent angle A1 with the central nozzle axis A, the second section 144 forms a divergent angle A2 with the central nozzle axis A. The angles A1/A2 can be tailored to facilitate focusing of the plasma. For example, on an absolute angle basis, the convergent angle A1 is equal to, greater than, or less than the divergent angle A2.

The first electrode 126 is disposed on the exterior side 24b of the dielectric nozzle 124, and the second electrode 130 is in the interior cavity 128. In the illustrated example, the second electrode 130 is conical and, more specifically, cylindro-conical. The term “cylindro-conical” refers to a geometry that has a cone on top of a cylinder, where the diameter of the base of the cone is equal to the diameter of the cylinder. Thus, the second electrode 130 has a cylindrical section 131a that serves as an electrode base at the backing plate 34 and a conical section 131b that has an apex 131c. The geometry of the second electrode 130 together with the geometry if the converging section 142 of the dielectric nozzle 124 defines a gap 132 between the second electrode and the interior side 24a of the dielectric nozzle 124 that varies in size (cross-sectional area) axially along the second electrode 130. For instance, the gap 132 is largest at the cylindrical section 131a, and then the gap 132 continually decreases in size from the conical section 131b to the throat 146. The size variation in the gap 132, particularly the gradual and continual narrowing of the gap 132 toward the apex 131c, serves to focus the generated plasma at the throat 146 via electron pressure gradient, thereby facilitating greater power density and collimation of the generated plasma (and thus also plasma acceleration efficiency).

As also shown in this example, the second electrode 130 extends through the throat 146 from the first section 142 to the second section 144. Only a short length of the second electrode 130 extends through the throat 146. For example, a radial plane through the throat 146 intersects the second electrode by some percentage of the total axial length of the second electrode 130. Such a configuration serves to further narrow the gap 132 at the throat 146, thereby enabling additional focusing of the plasma.

The device 120 also includes a magnet 140, on the exterior side 24b of the dielectric nozzle 124 that provides a magnetic field that serves to accelerate the plasma expelled from the open end 24d of the dielectric nozzle 124. The magnet 140 provides a magnetic field that serves to accelerate the plasma expelled from the open end 24d of the dielectric nozzle 124. For instance, the magnetic field generated by the magnet 140 captures the plasma downstream of the throat 146, thereby helping to reduce the loss of plasma from neutralization at the interior side 24a of the dielectric nozzle 124. The magnet 140 includes coils 140a that circumscribe the dielectric nozzle 124. In this example, the dielectric nozzle 124 serves as a bobbin around which the coils 140a are wound. In that regard, the magnet 140 resides in the triangular region defined on the exterior side 24b of the dielectric nozzle 124 by the inclinations of the walls that form the sections 142/144. The device 120 is thus compact, as the magnet 140 is within the envelope of the peripheral outline of the dielectric nozzle 124.

FIG. 3 again illustrates the device 120 (elements unlabeled), but with electric field vectors E, and magnetic field vectors B relative to plasma P. The divergent section 144 of the dielectric nozzle 124 acts as a discrete discharge region for the generated plasma P. The divergent section 144 also follows the divergent shape of both the electric field E and the magnetic field B from the vicinity of the throat 146. Thus, the divergent section 144 facilitates reduction in wall interactions with the plasma and concomitant enhancement in plasma beam collimation. Additionally, the magnet 140 drives ambipolar diffusion of ions and electrons as a downstream couple that will eventually detach them from the magnetic field. In comparison, in the “coaxial” configuration of the device 20 of FIG. 1, the dielectric nozzle 24 and gap 32 are each of constant cross-sections, which likely increases wall losses in the acceleration region due to the divergence of the electric and magnetic fields toward the wall, where the plasma neutralizes.

The convergent-divergent configuration of the device 120 of FIGS. 2 and 3 also may also provide greater electrical isolation and thus enhanced performance in comparison to the “coaxial” configuration of the device 20 of FIG. 1. For instance, the second electrode 30, with electrode sections 30a and 30b, is a more complex geometry and can result in undesired discharges at the backing plate 34 and/or in the gas passages feeding into the cavity 28, which in turn reduces power of the generated plasma plume emitted from the dielectric nozzle 24. However, the single second electrode 130 in the device 120 avoids that isolation complexity, thus reducing undesired discharges and thereby preserving more power in the generated plasma.

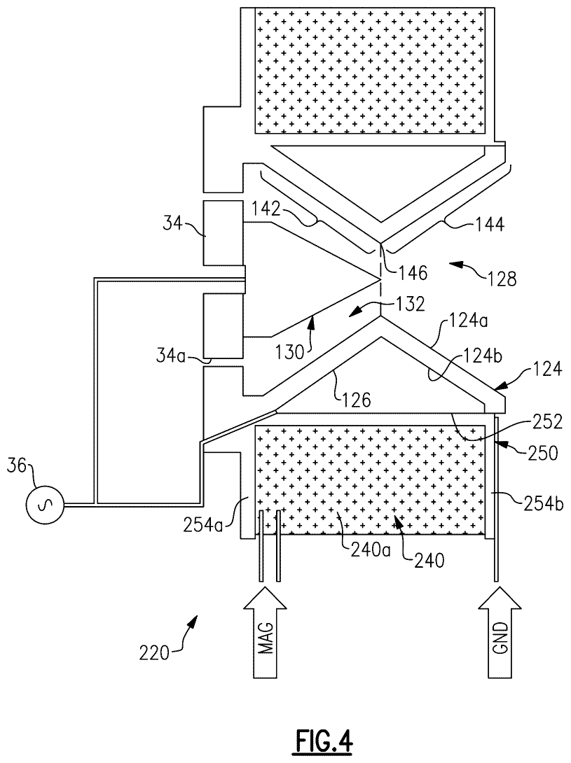

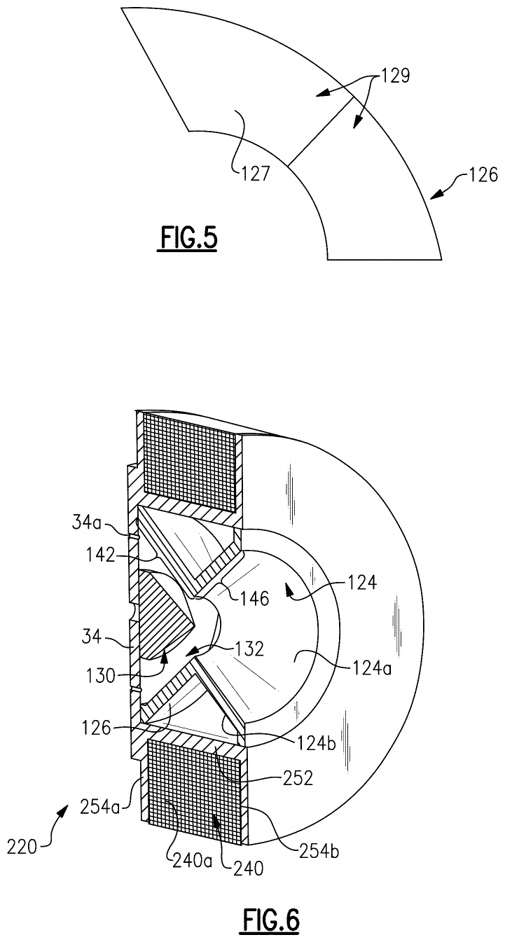

FIG. 4 illustrates another example device 220 that is the same as the device 120 except for the magnet 240 (see also the sectioned, three-dimensional rendering of the device 220 in FIG. 6). Like the magnet 140, the magnet 240 is on the exterior side 24b of the dielectric nozzle 124. However, the device 220 further includes a bobbin 250. The bobbin 250 has a cylinder 252 with a first flange 254a at a first axial end of the cylinder 252 and a second flange 254b at a second axial end of the cylinder 250. Magnet coils 240a are wound around the cylinder 252 of the bobbin 250. The dielectric nozzle 124 is disposed inside of the cylinder 252 of the bobbin 250. Optionally, the dielectric nozzle 252 is removeable from the cylinder 252, such as to swap the dielectric nozzle 124 out for another dielectric nozzle of different geometry (e.g., a nozzle having different angles A1/A2). However, in some end-use products there may not be a need for exchanging nozzles and, in that case, the dielectric nozzle 124 can be more permanently affixed in the cylinder 252.

The bobbin 250 and the coils 240a are thus outside of the triangular region defined on the exterior side 24b of the dielectric nozzle 124. Although this configuration may have a larger “footprint” than if the coils 240a were in the triangular region, the configuration may facilitate manufacturing benefits by integration of the bobbin 250. For example, the bobbin 250 and the backing plate 34 can be formed of a single, monolithic piece that thus reduce the number of parts and assembly steps.

FIG. 5 illustrates an isolated view of a portion of the first electrode 126 from device 120. The exterior side 24b of the dielectric nozzle 124 is dually frustoconical, with one frustum formed by the wall of the convergent section 142 and another frustum formed by the wall of the divergent section 144. The first electrode 126 is formed from, but not limited to, a metallic foil 127. The foil 127 may be provided as a sheet and then cut to a shape or shapes that conform to the frustum. As an example, the foil 127 is cut into arc segments 129 that can be attached together to correspond to the geometry of the frustum and thus enable the foil 127 to be wrapped onto the dielectric nozzle 124 without rippling or kinking. The foil 127 thus lies flat on the exterior side 24b, which facilitates uniformity in the generated electric field.

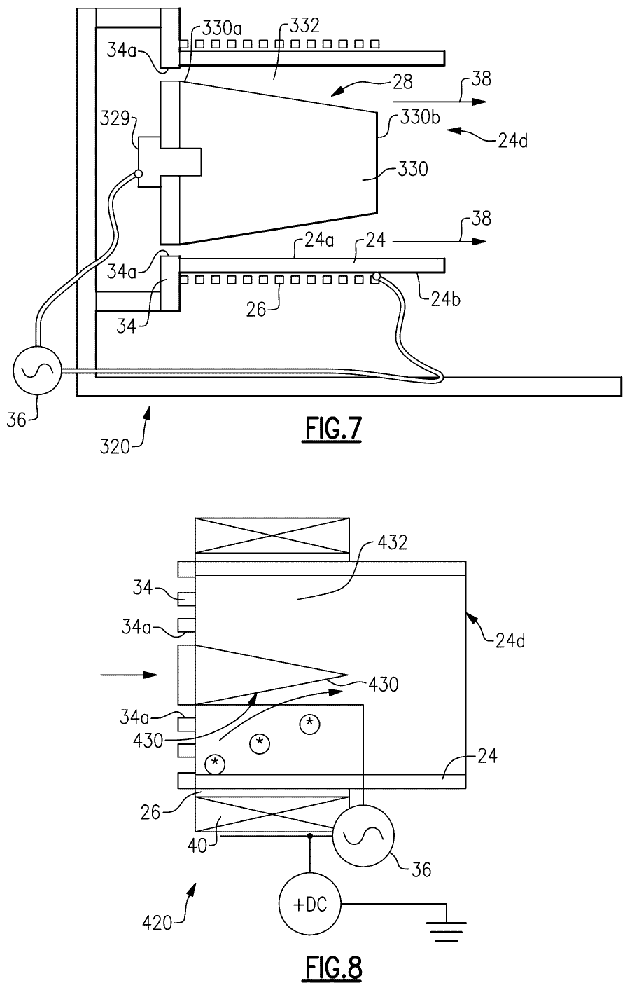

FIG. 7 illustrates another example dielectric barrier discharge device 320. Like the device 20, the device 320 has a cylindrical dielectric nozzle 24, but the second electrode 330 in the interior cavity 28 is frustoconical in shape such that the sides are sloped. In combination with the wall of the dielectric nozzle 24, the frustoconical shape provides a variable size gap 332 that functions similarly to the aforementioned gap 132. Also in this example, the first electrode 26 is a copper mesh, which may be encapsulated in a polymer material, such as epoxy.

The axial length of any of the magnets herein may ultimately be selected based, at least on part, on the shape of the magnetic field B for more optimal plasma acceleration. However, for a convergent-divergent configuration a magnet that fully axially overlaps the second electrode is thought to provide a divergent magnetic field shape that corresponds to the divergent section 146 of the nozzle 124, as already discussed above.

FIG. 8 illustrates another example device 420 that has elements previously described above. In this example, however, the second electrode 430 is entirely conical to provide a variable size gap 432 that functions similar to the aforementioned variable size gap 132.

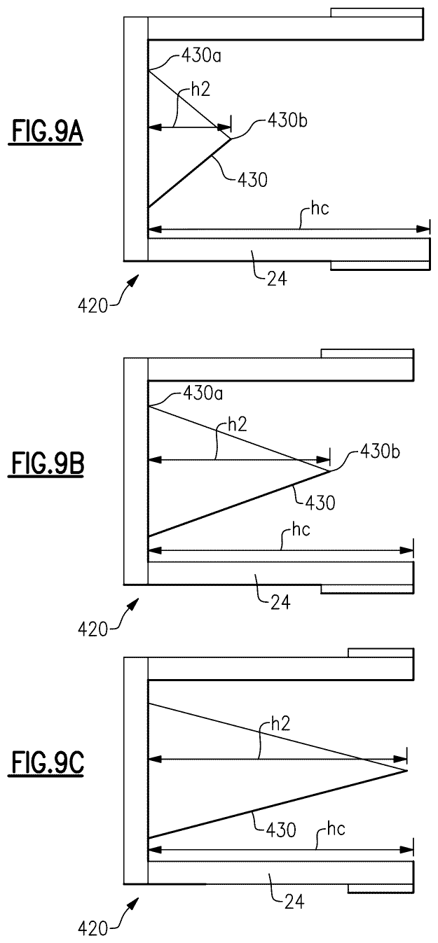

FIGS. 9A, 9B, and 9C demonstrate additional examples for tailoring the profile of the electric field and resulting plasma accelerating force in the device 420, the teachings of which can also be applied to the other examples herein. For instance, the dielectric nozzle 24 defines a cylinder height (hc), the second electrode 430 defines an electrode height (h2) from the cone base 430a to the apex 430b, and the electrode height (h2) is less than the cylinder height (hc). For instance, in FIG. 9A the electrode height (h2) is less than the cylinder height (hc) by a factor of at least 2. In FIG. 9B the electrode height (h2) is less than the cylinder height (hc) by a factor greater than 1 and up to 1.3, and in FIG. 9C the electrode height (h2) is equal to the cylinder height (hc).

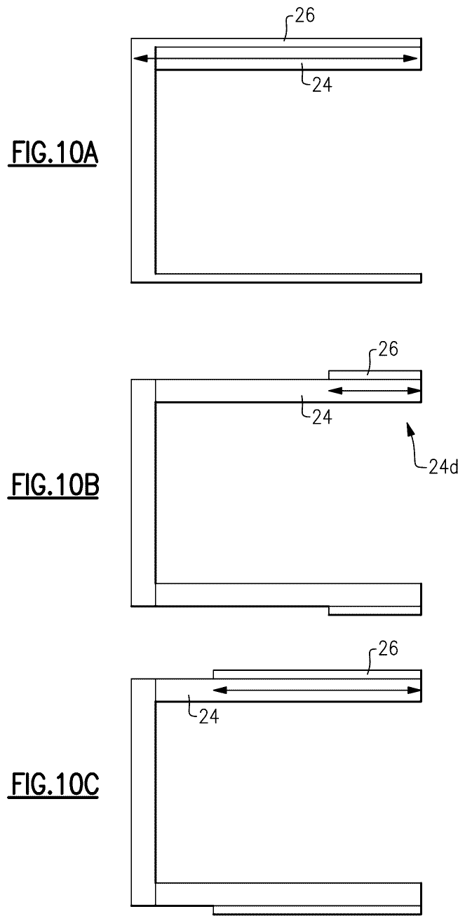

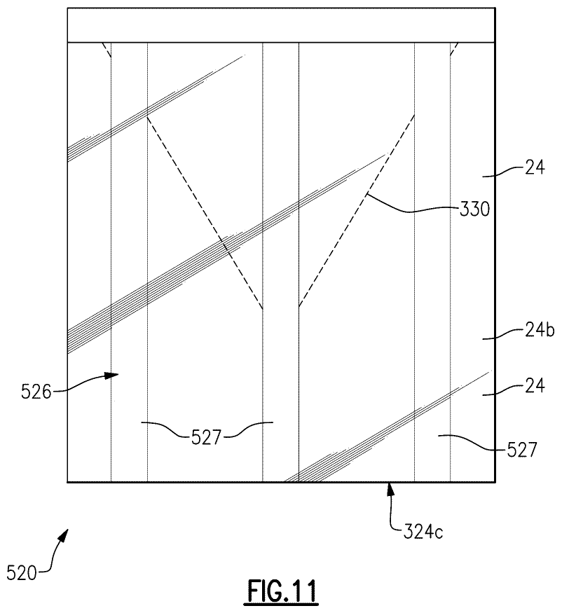

Furthermore, as demonstrated in FIGS. 10A, 10B, and 10C, the axial extent and location of the first electrode 26 may be varied to tailor the electric field shape. In FIG. 10A the first electrode 26 is coextensive with the dielectric cylinder 24. In FIG. 10B, the first electrode 26 is situated toward the open end 24d of the dielectric nozzle 24 and extends from the open end 324c down approximately one-third of the length of the dielectric nozzle 24. In FIG. 10C, the first electrode 26 is situated toward the open end 24d of the dielectric nozzle 24 and extends from the open end 24d down approximately two-thirds of the length of the dielectric nozzle 24. Similar to the magnetic field B, the length and axial position of the first electrode 26 may ultimately be selected based, at least on part, on the shape of the electric field E for more optimal plasma acceleration.

FIG. 11 illustrates a side view of another example device 520. The device 520 is similar to the device 320, but in this example the first electrode 526 includes electrode strips 527 that are circumferentially spaced around the exterior side 24b of the dielectric cylinder 24. The strips 527 are axially elongated (relative to the central axis of the dielectric cylinder 324) and are uniformly spaced-apart by a distance that is greater than the width the strips 527 in the circumferential direction. The device 520 can be used to thermally decompose and accelerate hydrazine or other liquid storable propellants. The number of strips 527, width of the strips, and spacing of the strips can also be tailored in order to control density of electric current arc filaments. For instance, the devices herein may be used as an alternative to a catalyst-based hydrazine configuration, to instead thermally decompose the hydrazine within the arc filaments generated in the device, while also adding an electrostatic or electromagnetic body force.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A dielectric barrier discharge device comprising:
a dielectric nozzle circumscribing an interior cavity, the dielectric nozzle having a first end, a second end opposite the first end, an interior side, and an exterior side opposite the interior side, the interior cavity spanning from the first end to the second end, and the interior cavity having an open end at the second end of the dielectric nozzle;
a first electrode on the exterior side;
a second electrode in the interior cavity;
a gas inlet fluidly connected with the interior cavity;
a gap running between the second electrode and the interior side; and
a power supply electrically coupled with the first electrode and the second electrode.

2. The dielectric barrier discharge device as recited in claim 1, wherein the gap varies in size along the second electrode.

3. The dielectric barrier discharge device as recited in claim 1, wherein the power supply, upon activation, generates a plasma from gas flowing into the interior cavity from the gas inlet and the plasma is expelled from the open end of the interior cavity.

4. The dielectric barrier discharge device as recited in claim 1, wherein the dielectric nozzle is disposed about a central nozzle axis extending from the first end to the second end, the dielectric nozzle defines a first section, a second section, and a throat axially between the first section and the second section, the first section converging from the first end to the throat, the second section diverging from the throat to the second end, and the throat is a minimum cross-sectional area of the interior cavity.

5. The dielectric barrier discharge device as recited in claim 3, wherein the second electrode is conical and extends through the throat from the first section into the second section.

6. The dielectric barrier discharge device as recited in claim 1, wherein the second electrode is conical.

7. The dielectric barrier discharge device as recited in claim 1, wherein the second electrode is cylindro-conical.

8. The dielectric barrier discharge device as recited in claim 1, further comprising an electromagnet on the exterior side of the dielectric nozzle, the electromagnet including coils that circumscribe the dielectric nozzle.

9. The dielectric barrier discharge device as recited in claim 8, further comprising a bobbin that has a cylinder with a first flange at a first axial end of the cylinder and a second flange at a second axial end of the cylinder, wherein the coils are wound on the cylinder of the bobbin.

10. The dielectric barrier discharge device as recited in claim 9, wherein the dielectric nozzle is disposed in the cylinder of the bobbin.

11. The dielectric barrier discharge device as recited in claim 8, wherein the coils are wound on the dielectric nozzle.

12. The dielectric barrier discharge device as recited in claim 1, wherein the dielectric nozzle is disposed about a central nozzle axis extending from the first end to the second end, the dielectric nozzle is cylindrical, the second electrode includes a cylindrical section, and the dielectric nozzle and the cylindrical section are coaxial about the central nozzle axis.

13. The dielectric barrier discharge device as recited in claim 12, wherein the first electrode further comprises an electrode post section that includes a wire encased in a dielectric shell, and the electrode post section is disposed along the central nozzle axis so as to be coaxial with the dielectric nozzle and the cylindrical section.

14. The dielectric barrier discharge device as recited in claim 1, wherein the second electrode is frustoconical.

15. The dielectric barrier discharge device as recited in claim 1, wherein the dielectric nozzle defines a nozzle height h1 in an axial direction, the second electrode defines an electrode height h2 from a base to a tip in the axial direction, and the electrode height h2 is less than the nozzle height h1.

16. The dielectric barrier discharge device as recited in claim 15, wherein the first electrode is situated toward the second end of the dielectric nozzle.

17. The dielectric barrier discharge device as recited in claim 15, wherein the first electrode is cylindrical.

18. The dielectric barrier discharge device as recited in claim 1, wherein the first electrode includes electrode strips that are circumferentially spaced around the exterior side of the dielectric nozzle.

19. The dielectric barrier discharge device as recited in claim 1, further comprising a magnetic ring on the dielectric nozzle and circumscribing the second end.
